(19) United States
(12) Patent Application Publication
(10) Pub. No.: US 2008/0059218 A1
(43) Pub. Date: Mar. 6, 2008

(54) Methods and systems for recommending a personal care product

(76) Inventors: John Phelps Sottery, Milford, CT (US); Patricia Alison LaFleur, Shrewsbury, PA (US)

Correspondence Address: THE PROCTER & GAMBLE COMPANY;INTELLECTUAL PROPERTY DIVISION - WEST BLDG., WINTON HILL BUSINESS CENTER - BOX 412, 6250 CENTER HILL AVENUE, CINCINNATI, OH, 45224, US

(21) Appl. No.: 11/804,801

(22) Filed: May 21, 2007

Related U.S. Application Data
(63) Continuation-in-part of application No. 10/965,534, filed on Oct. 14, 2004.

(51) Int. Cl. G06Q 99/00; H04M 1/02; H04N 3/14

(52) U.S. Cl. 705/1; 348/311; 455/556.1; 348/E03.011

(57) ABSTRACT

Methods and apparatus for measuring an electromagnetic radiation response property associated with a substrate and selecting a color for use by a personal care product recommendation system based on the measurement are disclosed. The method positions an electromagnetic source, an electromagnetic capture device, and, in certain embodiments, a plurality of filters in a predetermined arrangement in order to construct an apparatus for measuring an electromagnetic radiation response property associated with a substrate and one or more calibration standards. A retail customer self-aligns a portion of his/her body and the standard(s) with the apparatus and triggers an electromagnetic measurement. Digital data is determined from captured electromagnetic waves. Based on the digital data, the customer is given certain choices and/or informed of certain personal care product recommendations.

### CROSS REFERENCE TO RELATED APPLICATION

This application is a continuation-in-Part of U.S. application Ser. No. 10/965,534, filed Oct. 14, 2004.

### FIELD OF THE INVENTION

The present invention relates in general to recommendation systems and, in particular, to methods and systems for personal care product recommendations.

### BACKGROUND OF THE INVENTION

Countless individuals all over the world seek to improve their physical appearance through the use of personal care products such as cosmetics and skin care treatments. As a result there is an extremely large choice of available products for consumers to choose from. Often, the individual consumer finds it difficult to determine what type of products to apply and what color(s) work best for them. This problem is compounded as the individual's skin condition changes over time and/or society's norms change over time.

Beauty counselors at retail cosmetics counters are charged with assisting customers in identifying personal care products aimed at improving the customer's appearance. However, such consultations are very subjective. Not all beauty counselors identify the same type or color of personal care products. Consultation results can vary from visit to visit, even with the same counselor and client. In addition, employment of beauty counselors increase the cost of the personal care products, and many customers do not want to be inconvenienced by approaching a beauty counselor.

### BRIEF DESCRIPTION OF THE DRAWINGS

Features and advantages of the disclosed methods and apparatus will be apparent to those of ordinary skill in the art in view of the detailed description of certain examples which is made with reference to the drawings, a brief description of which is provided below.

FIG. 1 is a block diagram of an apparatus structured to measure an electromagnetic radiation response property associated with a substrate for use with methods and systems for recommending personal care products according to the present disclosure.

FIG. 2 is a more detailed block diagram of the apparatus illustrated in FIG. 1.

FIGS. 3A-3C is a flowchart of a process for measuring an electromagnetic radiation response property associated with a substrate.

FIG. 4 is a block diagram of an alternative apparatus for use with methods and systems for recommending personal care products according to the present disclosure.

FIG. 5 is a flowchart of a process for measuring an electromagnetic radiation response property associated with a substrate and recommending a personal care product in accordance therewith.

### DETAILED DESCRIPTION OF EXAMPLE EMBODIMENTS

In general, the methods, systems and apparatuses described herein use an electromagnetic capture device in a system for recommending a personal care product. It is intended that the user, for example a retail customer, be able to operate the apparatus according to the present disclosure without assistance. Specifically, the user self-aligns the substrate to be measured, e.g., a portion of his/her body, and one or more calibration standards with the apparatus and triggers an electromagnetic measurement. In response, the apparatus captures electromagnetic waves from the substrate. Digital data is determined from the captured electromagnetic waves. Based on the digital data, the customer is given certain choices and/or informed of certain recommendations, e.g., personal care product recommendations.

According to one embodiment, the apparatus also includes an electromagnetic source and a plurality of filters in a predetermined arrangement to be used in measuring an electromagnetic radiation response property associated with a substrate. In this embodiment, at least a portion of the waves generated by the source are captured after the waves pass through a first polarized filter, reflect from the user, and pass through a second polarized filter arranged in a cross polar arrangement with respect to the first polarized filter. Addition, although not necessarily, the apparatus may capture electromagnetic waves that pass through an attenuating filter and reflect from the one or more calibration standards. In such a circumstance, the digital data may also be used to calibrate and/or recalibrate the apparatus.

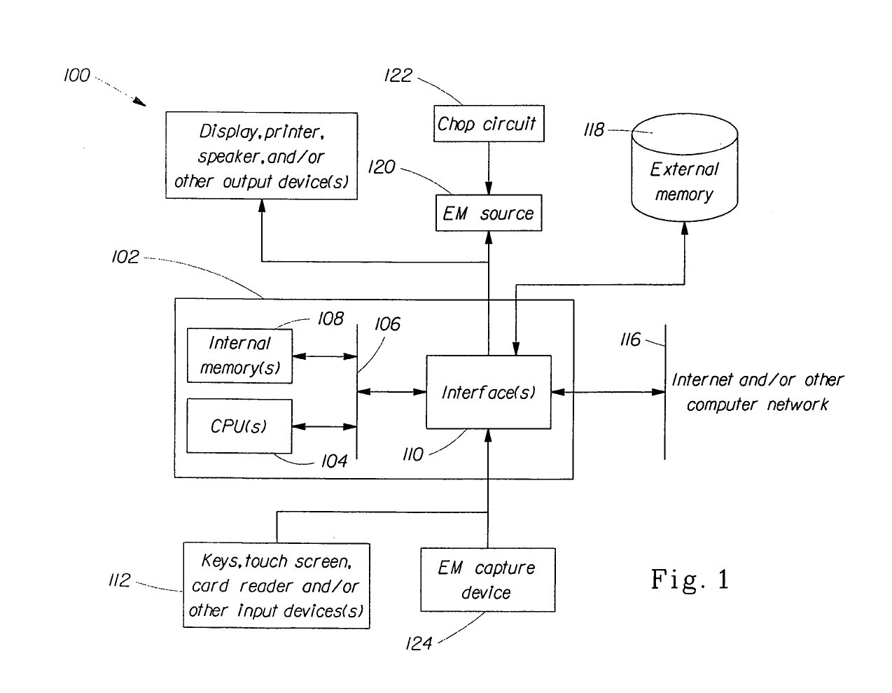

A block diagram of an apparatus 100 structured to measure an electromagnetic radiation response property associated with a non-homogeneous/homogeneous shiny or matte substrate is illustrated in FIG. 1. The apparatus 100 includes a controller 102 which preferably includes one or more processing units 104 electrically coupled by an address/data bus 106 to one or more internal memory devices 108 and one or more interface circuits 110. Each processing unit 104 may be any type of well known microprocessor, microcontroller, digital signal processor, specialized mathematical processor, and/or any other type of computing device. The memory device(s) 108 may include volatile memory and/or non-volatile memory. Preferably, the memory device(s) 108 store a software/firmware program that controls unit functions and interacts with a plurality of other devices as described in detail below. This program may be executed by the processing unit(s) 104 in a well known manner. The memory device(s) 108 may also store digital data indicative of screen displays, bit maps, user instructions, personal identification information, demographic data, digitized images, color data, light intensity data, histogram data, and/or other data used by the apparatus 100 and/or collected by the apparatus 100.

The interface circuit 110 may be implemented using any type of well known interface standard, such as an Ethernet interface, a Universal Serial Bus (USB) interface, and/or one or more proprietary interfaces. One or more input devices 112 may be connected to the interface circuit 110 for entering data, signals, user identification information, commands, and/or other information into the controller 102. For example, the input device 112 may be one or more keys, one or more buttons, a touch screen, a card reader and/or other input device(s).

One or more displays, printers, speakers, and/or other output devices 114 may also be connected to the controller 102 via the interface circuit 110. The display 114 may be cathode ray tube (CRTs), liquid crystal displays (LCDs), or any other type of display. The display 114 may generate visual displays of data generated and/or retrieved during operation of the apparatus 100. The visual displays may include prompts for human input, calculated values, detected data, etc. The display 114 is typically used to display instructions and product recommendations to a user. For example, the visual displays may instruct a retail customer how to self-align using a pair of eye positioning frames and trigger a measurement by pushing a button 112. In addition, the instructions may request certain consumer data and/or personal identification information. Still further, the display may inform a customer of a particular product name and/or color.

The apparatus 100 may also exchange data with other devices via a connection to a network 116. The network connection may be any type of network connection. For example, the network connection may be, but is not limited to, an Ethernet connection, digital subscriber line (DSL), telephone line, or coaxial cable. Of course, a person of ordinary skill in the art will readily appreciate that any type of data connection, such as a direct connection, may be used. Users of the apparatus 100 may be asked to register. In such an instance, each user may choose a user identifier and a password that may be required for the activation of services. The user identifier and/or password may be entered into the apparatus 100 via a card reader and/or other input device 112.

The apparatus 100 may also include one or more external memory devices 118. For example, the apparatus 100 may include one or more flash card readers, hard drives, a compact disk (CD) drive, a digital versatile disk drive (DVD), and/or other computer media input/output (I/O) devices.

To produce a certain type of electromagnetic wave, the apparatus 100 may include an electromagnetic source 120, which may include one or more filters, such as infrared, ultraviolet, visible light, chop and/or band pass. In one example, the electromagnetic source 120 produces a pulse of electromagnetic energy using a flash, such as a xenon flash lamp, a linear flash and/or a ring flash. In another example, the electromagnetic source 120 is a continuous source.

The apparatus 100 may also include an exposure timer circuit 122, such as a thyristor circuit. The exposure timer circuit 122 cuts off the electromagnetic source 120 when a predetermined amount of electromagnetic radiation is detected. The exposure timer circuit 122 may be connected to the electromagnetic source 120 directly (as shown) or indirectly via the controller 102.

The apparatus 100 also includes an electromagnetic (EM) capture device 124 which may also include a shutter mechanism to control the time the electromagnetic capture device is exposed to the electromagnetic signal. The electromagnetic capture device 124 produces an electrical signal in response to an electromagnetic signal. The electromagnetic capture device 124 “captures” electromagnetic waves, such as light waves, infrared waves, and/or ultraviolet waves. The electromagnetic capture device 124 may be any type of well known electromagnetic capture device. For example, the electromagnetic capture device 124 may be a charge coupled device (CCD), a CMOS device, and/or a linear photo diode array.

Preferably, the captured waves are represented by a digital value indicative of light intensity. For example, three digital values may be used to represent the light intensity in each of a red, a green, and a blue color spectrum. In such an instance, the electromagnetic capture device 124 may include color filters corresponding to the represented wavelength regions. Of course, a person of ordinary skill in the art will readily appreciate that any band of wavelength may be represented, such as a yellow band, an infrared band, and/or an ultraviolet band.

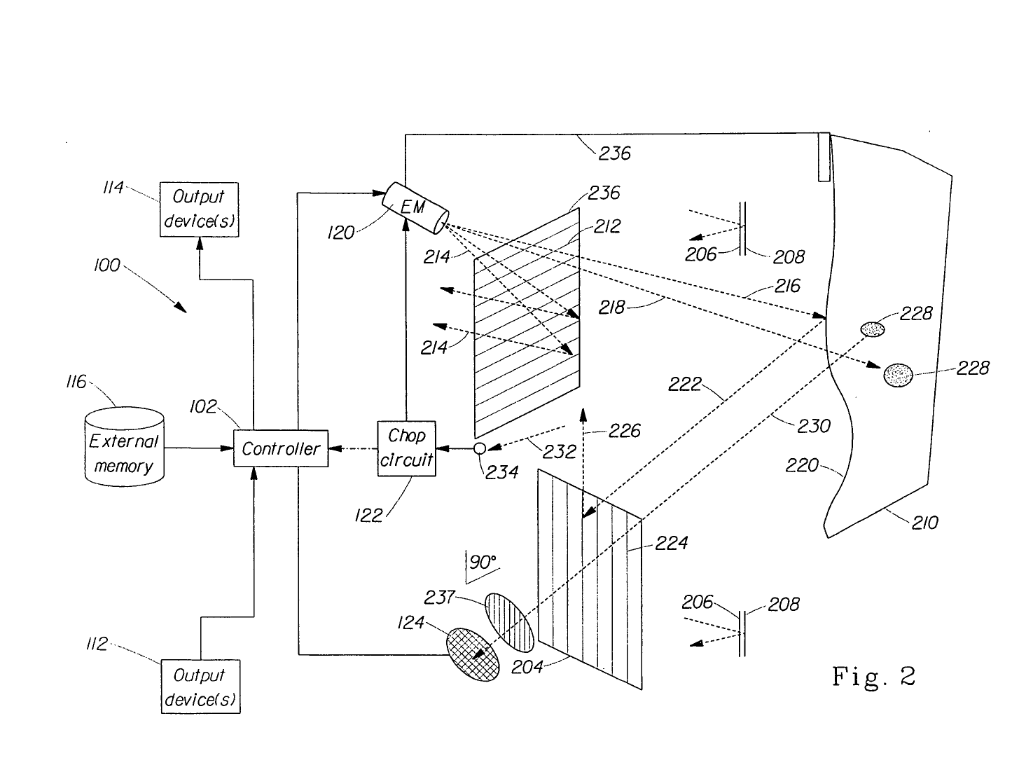

A block diagram of the apparatus 100 with additional details shown is illustrated in FIG. 2. Specifically, a first polarized filter 202, a second polarized filter 204, an attenuating filter 206, one or more calibration standards 208, and a lens 237 are shown. The first polarized filter 202 may be located between the electromagnetic source 120 and a substrate 210. The second polarized filter 204 may be located between the substrate 210 and the electromagnetic capture device 124. The lens 237 may be located between the second polarized filter 204 and the electromagnetic capture device 124. The lens 237 may be any material (glass, quartz, plastic, fused silica) that allows electromagnetic radiation of specific wavelengths to pass through, and may also include an adjustable or fixed aperture to attenuate the electromagnetic radiation.

The first polarized filter 202 may be any type of material that only allows light with a specific plane of polarization to pass through. The direction of fluctuation passed by a polarized filter is often called the “easy” axis or the “optical” axis. The first polarized filter 202 is arranged such that the optical axis 212 associated with the first polarized filter 202 is aligned in a predetermined direction. For example, the first polarized filter 202 may be arranged such that the optical axis 212 associated with the first polarized filter 202 is aligned horizontally with respect to the floor of an installation site or retail point of sale. Accordingly, some electromagnetic waves 214 emanating from the electromagnetic source 120 may be absorbed and/or reflected by the first polarized filter 202. In other words, all (or almost all) of the electromagnetic waves 216, 218 passing through the first polarized filter 202 will be linearly polarized in a first direction dictated by the optical axis 212 of the first polarized filter 202.

The substrate 210 may be any material. Preferably, the substrate 210 is a portion of a human body. For example, the substrate 210 may be a portion of a human face, a human tooth, human hair, a human chest, a human neck, a human arm, a human hand, and/or a human leg. A substrate surface 220 reflects some of the electromagnetic waves 222 generated by the electromagnetic source 120. Typically, a significant fraction of these reflected electromagnetic waves 222 are linearly polarized in the same plane as the incident electromagnetic waves 216 (i.e., for waves specularly reflected from a surface, polarization is maintained). In other words, many of the reflected waves 222 are linearly polarized in a direction dictated by the optical axis 212 of the first polarized filter 202.

The second polarized filter 204 may also be any type of material that only allows light with a specific plane of polarization to pass through. The second polarized filter 204 is preferably arranged such that the optical axis 224 associated with the second polarized filter 204 is non-parallel with respect to the optical axis 212 associated with the first polarized filter 202 (i.e., forming a non-zero angle). For example, the second polarized filter 204 may be arranged such that the optical axis 224 associated with the second polarized filter 204 is nearly perpendicular (e.g., forming an angle between 70 and 110 degrees) or substantially perpendicular (e.g., forming an angle between 85 and 95 degrees) to the optical axis 212 associated with the first polarized filter 202. Accordingly, reflected waves 222 which are linearly polarized in a direction dictated by the optical axis 212 of the first polarized filter 202 may be further absorbed and/or reflected 226 by the second polarized filter 204. In other words, a large percentage of the electromagnetic waves which are generated by the electromagnetic source 120 and reflected by the substrate surface 212 are blocked by the second polarized filter 204 and do not arrive at the electromagnetic capture device 124.

Concurrently, some of the electromagnetic waves 218, which are generated by the electromagnetic source 120 and pass through the first polarized filter 202, start out to be linearly polarized in a first direction dictated by the optical axis 212 of the first polarized filter 202. However, some fraction of these electromagnetic waves 218 penetrate through the substrate surface 220 and undergo one or more scattering events against internal substrate masses 228. In such an instance, some fraction of the incident electromagnetic waves 218 may emerge from the substrate 210 as a wave 230 with a different polarization. Some fraction of the emergent wave 230 may be linearly polarized (in whole or in part) in a second direction consistent with the optical axis 224 of the second polarized filter 204. Accordingly, such an electromagnetic wave 230 passes through the second polarized filter 204 with minimum attenuation, passes through the lens 237 and arrives at the electromagnetic capture device 124. In this manner, much of the “surface reflection” is eliminated from the electromagnetic measurement, while a significant portion of the remitted electromagnetic waves (i.e., waves that have undergone one or more scattering events with internal substrate mass) are used in the electromagnetic measurement. In this manner, the system effectively discriminates against electromagnetic waves that reflect off the substrate surface (polarization maintained) and preferentially measures the (depolarized) electromagnetic waves that are remitted from the substrate after one or more collisions with internal substrate masses.

Furthermore, background electromagnetic radiation (electromagnetic radiation that is present in the environment and not produced by the apparatus 100) can adversely affect the measurement of the substrate. Thus the variables that impact the response of the system to background electromagnetic radiation including the lens, lens aperture, transmittance of the polarizing filters, period of time the electromagnetic radiation is allowed to strike the electromagnetic capture device and the inherent sensitivity/integration time of the electromagnetic capture device need to be selected such that the electromagnetic capture device does not yield an appreciable signal from the background electromagnetic radiation. For example, in one preferred embodiment, a lens aperture of F8, coupled with 38% transmission polarizing filters, an exposure time of 2 milliseconds and a CMOS inherent sensitivity/integration time equivalent to ISO 100 yielded no appreciable signal for background electromagnetic radiation.

One or more attenuating filters 206 and one or more calibration standards 208 may be used to calibrate the apparatus each time a substrate measurement is taken. The calibration standards may be any type of material, such as a blend of pigments fixed in a polymer and/or protein matrix. Preferably, the calibration standards 208 reflect the electromagnetic waves generated by the electromagnetic source 120 in a manner which is similar to the way the substrate 210 reflects the electromagnetic waves generated by the electromagnetic source 120. For example, one calibration standard 208 may reflect one color that is typical for the substrate 210 being tested (e.g., light skin color, yellow skin color, etc.), and another calibration standard 208 may reflect another color that is typical for the substrate 210 being tested (e.g., dark skin color, red skin color, etc). Each of these colors is associated with a known digital value. As a result, digital values obtained from measuring unknown substrates 210 may be compared to these known values each time a measurement is taken in order to ensure calibration in a cost-effective manner.

However, in one embodiment, a calibration standard 208 is included. Preferably, the standards 208 and the substrate 210 are protected from environmental damage by one or more housings. According to certain embodiments, the standard 208 may be positioned through the use of holders that are coupled to one or more of these standards through a mechanical attachment. For example, the standard 208 may be secured to an arm using a clip-type holder, which arm is in turn secured to a housing by a mechanical attachment mechanism, such as a fastener in the form of a screw. Alternatively, the arm of the holder could be attached to the housing through the use of adhesives or welding, for example. Similarly, the substrate alignment device may be attached through the use of fasteners, adhesives, etc.

The calibration standards 208 may be located in a different plane than the substrate 210. For example, the calibration standards 208 may be located a first distance from the electromagnetic source 120, and the substrate 210 may be located a second distance from the electromagnetic source 120, wherein the first distance is shorter than the second distance (i.e., the calibration standards 208 may be closer to the electromagnetic source 120 than the substrate 210). As a result, the calibration standards 208 receive more electromagnetic energy per unit area than the more distant substrate 210. In such an instance, an attenuating filter 206 may be placed between the electromagnetic source 120 and the calibration standards 208 in order to attenuate the amount of electromagnetic energy reaching the calibration standards 208. Preferably, the percentage of attenuation associated with the attenuating filter 206 is based on a function of the ratio of the first distance (i.e., distance from electromagnetic source 120 to calibration standards 208) and the second distance (i.e., distance from electromagnetic source 120 to substrate 210).

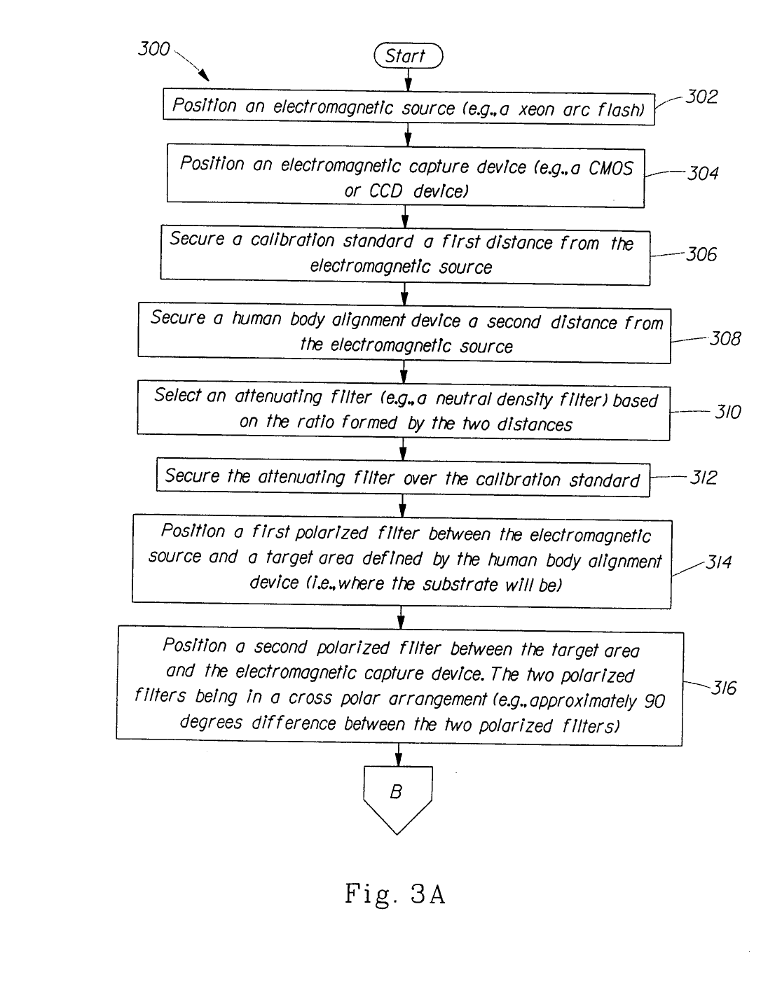

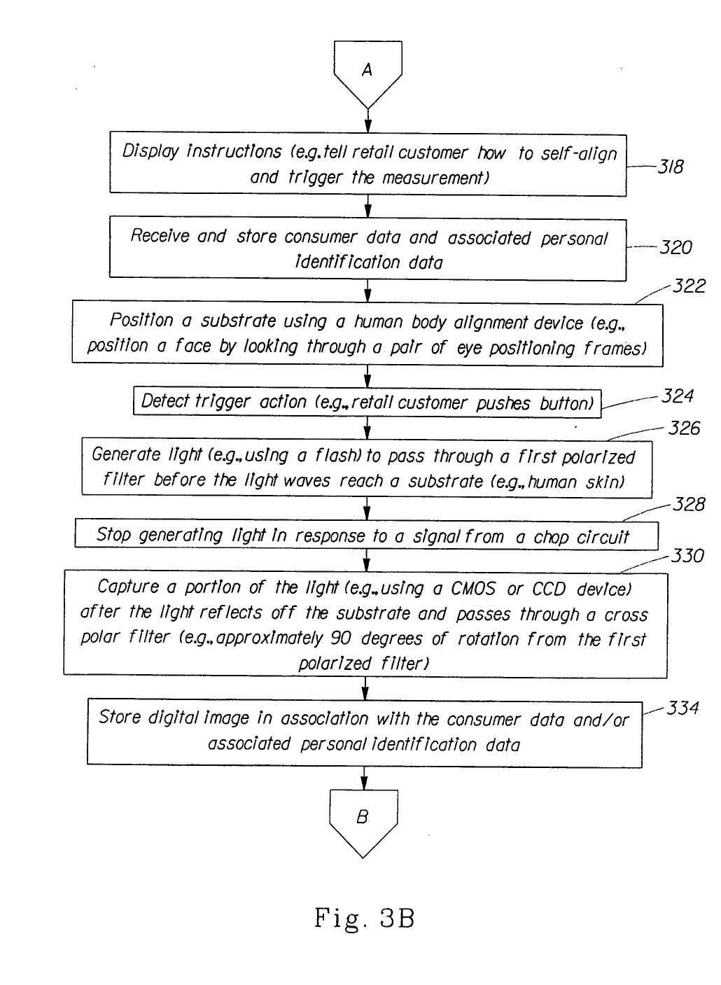

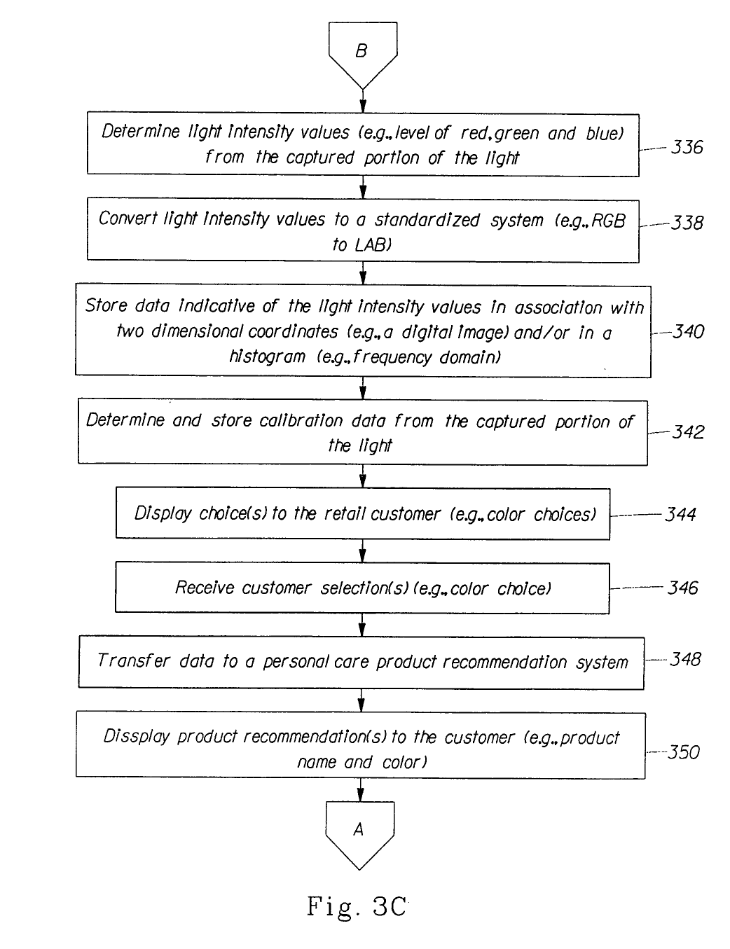

A flowchart of a process 300 for measuring an electromagnetic radiation response property associated with a substrate is illustrated in FIG. 3. Preferably, part of the process 300 is embodied in a software program which is stored in a controller memory 108, 118 and executed by the controller processing unit 104 in a well known manner. However, some of the steps of the process 300 may be performed manually and/or by another device. Although the process 300 is described with reference to the flowchart illustrated in FIG. 3, a person of ordinary skill in the art will readily appreciate that many other methods of performing the acts associated with process 300 may be used. For example, the order of many of the steps may be changed. In addition, many of the steps described are optional.

Generally, the process 300 positions an electromagnetic source 120, an electromagnetic capture device 124, and a plurality of filters 202, 204, 206 in a predetermined arrangement, by attaching these devices to one or more housings through the use of fasteners, adhesives, etc., in order to construct an apparatus 100 for measuring an electromagnetic radiation response property associated with a substrate 210. A retail customer may operate the apparatus 100 without assistance. Specifically, the customer self-aligns a portion of his/her body with the apparatus 100 and triggers an electromagnetic measurement. In response, the apparatus 100 generates electromagnetic waves and captures a portion of the generated waves after the waves pass through a first polarized filter 202, reflect from the customer (i.e., the substrate 210 and/or the substrate surface 220), and pass through a second polarized filter 204 arranged in a cross polar arrangement with respect to the first polarized filter 202 and pass through the lens 237. In addition, the apparatus 100 captures electromagnetic waves that pass through an optional attenuating filter 206 and reflect from the calibration standards 208. Digital data is determined from the captured electromagnetic waves. Based on the digital data, the customer is given certain choices and/or informed of certain personal care product recommendations. In addition, the digital data may be used to calibrate/recalibrate the apparatus.

The process 300 begins when an electromagnetic source 120 is placed in a predetermined position (block 302). For example, a xenon flash lamp may be attached by fasteners, adhesives, etc. to a housing and/or the housing may be fixed to a structure at a retail point of sale. Similarly, an electromagnetic capture device 124 is attached in a predetermined position relative to the electromagnetic source 120 (block 304). For example, a charge coupled device, a CMOS device, and/or a linear photo diode array may be attached in approximately the same location as the electromagnetic capture device 124. In addition, one or more calibration standards 208 may be attached to the housing at a first predetermined distance from the electromagnetic source 120 (block 306). For example, several different color standards may be attached inside the housing of the apparatus 100. Similarly, a human body alignment device 236 is attached a second distance from the electromagnetic source 120 (block 308).

Once these two distances are determined, an attenuating filter 206 may be selected based on a function of the ratio formed by the two distances (block 310). For example, a neutral density filter that attenuates light or other electromagnetic waves by a certain percentage (e.g., absorbance between 0.1 and 3.0) may be selected based on the ratio. Larger ratios of the second distance over the first distance indicate a larger amount of attenuation should be used in order to simulate an arrangement where the calibration standards 208 are in approximately the same plane as the substrate 210. Once the attenuating filter 206 is selected, the attenuating filter 206 may be secured over the calibration standards 208 (block 312).

In addition, a first polarized filter is attached between the electromagnetic source 120 and a target area defined by the human body alignment device 236 (block 314). The human body alignment device 236 defines approximately where the substrate 210 will be positioned during a measurement by the apparatus 100. The human body alignment device 236 may be any type of alignment device, such as a pair of eye positioning frames. Eye positioning frames may be used to position a human head for measurement of any portion of the human head, such as hair, teeth, face, neck, etc.

Similarly, a second polarized filter is attached between the target area (as defined by the human body alignment device 236) and the electromagnetic capture device 124 (block 316). The two polarized filters are placed in a cross polar arrangement. In other words, the optical axis 212 of the first polarized filter is not parallel to the optical axis 224 of the second polarized filter. Preferably, the two optical axes 212, 224 are separated by approximately ninety degrees.

A lens 237 is optionally attached between the second polarized filter 204 and the electromagnetic capture device 124. Once the measurement apparatus 100 is constructed, the apparatus preferably displays instructions on an output device 114 (block 318). Preferably, the instructions are indicative of a procedure, at least a portion of which the retail customer is to perform without retail employee assistance. The procedure facilitates alignment of the retail customer with the apparatus 100 using the human body alignment device 236. In addition, the instructions preferably include an action the retail customer is to perform in order to trigger an electromagnetic measurement by the apparatus 100. For example, the instructions may tell a retail customer how to self-align using a pair of eye positioning frames and trigger a measurement by pushing a button 112. In addition, the instructions may request certain consumer data and/or personal identification information. In such an instance, the apparatus 100 receives the consumer data and/or personal identification information via one or more input devices 112 and stores the consumer data and/or personal identification information in a memory 108, 118 (block 320). For example, the apparatus 100 may receive personal identification information via a personal identification device such as a card reader and/or a touch screen device. Subsequently, the substrate 210 is positioned using the human body alignment device 236 (block 322). For example, a pair of eye positioning frames may be used to position a human face for measurement.

Once the trigger action is detected (block 324), the apparatus 100 generates electromagnetic radiation (block 326). For example, a retail customer being measured may self-align using the eye positioning frames and push a button to trigger the measurement. In response, the apparatus 100 may trigger a flash, such as a xenon flash. Of course, a person of ordinary skill in the art will readily appreciate that a continuous light source or any electromagnetic source may be used. For example, an infrared and/or an ultraviolet source may be used. Some of the electromagnetic waves 216, 218 generated by the electromagnetic source 120 then pass through the first polarized filter 202 before the waves reach the substrate 210. Other electromagnetic waves 214 generated by the electromagnetic source 120 do not pass through the first polarized filter 202. Instead, these waves 214 are absorbed and/or reflected by the first polarized filter 202. As a result, the electromagnetic waves 216, 218 passing through the first polarized filter 202 are linearly polarized in a first direction dictated by the optical axis 212 of the first polarized filter 202.

Some of the electromagnetic waves 232 that pass through the first polarized filter 202 reflect from the substrate 210 and strike a photo detector 234 which is part of the exposure timer circuit 122. If a predetermined amount of electromagnetic radiation reaches the detector 234, the exposure timer circuit 122 preferably cuts off the electromagnetic source 120 (block 328). In this manner, insufficient lighting and/or saturation of the electromagnetic capture device 124 is avoided. For example, a “light” substrate preferably causes the exposure timer circuit 122 to trigger earlier than a “dark” substrate. In conjunction with the calibration standards, this technique allows a greater dynamic range of substrate shades accurately measured (e.g., from very light to very dark).

Some of the electromagnetic waves 216, 222, 226 that pass through the first polarized filter 202 reflect from the substrate surface 220 and are absorbed and/or reflected by the second polarized filter 204. However, some of the electromagnetic waves 218, 230 that pass through the first polarized filter 202 reflect from internal substrate masses 228 and pass through the second polarized filter 204 and the lens 237. These waves 218, 230 are captured by the electromagnetic capture device 124 (block 330). Different waves captured by the electromagnetic capture device 124 at different X-Y coordinates of the electromagnetic capture device 124 may be stored separately in a two-dimensional data matrix (block 334). This two-dimensional matrix may be stored in conjunction with the consumer data and/or the personal identification data associated with this retail customer (block 334).

The light intensity values may be converted from the original color space to any other color space (block 338) prior to or after creating a histogram. For example, the light intensity value may be converted from a RGB (red-green-blue) system to a LAB (light-yellow-red) and/or a LCH (light-chroma-hue) system. Digital representations of the different waves or converted versions thereof captured at the different X-Y coordinates of the electromagnetic capture device 124 may be combined in to a histogram by determining the light intensity values associated with each of the different X-Y coordinates and counting the number of occurrences of each light intensity value (or each of a range of light intensity values) (block 336). One or more of the above combinations of data is stored in an apparatus memory 108, 118 (block 340).

As discussed above, one or more calibration standards 208 reflect the electromagnetic waves generated by the electromagnetic source 120 in a manner that is similar to the way the substrate 210 and/or substrate surface 220 reflects the electromagnetic waves generated by the electromagnetic source 120. Each calibration standard 208 is associated with a known digital value. Accordingly, digital data indicative of electromagnetic radiation intensities captured by the electromagnetic capture device 124 in areas where one or more calibration standards 208 is known to be located may be stored in an apparatus memory 108, 118 and used to calibrate the apparatus 100 for the current and/or subsequent measurements (block 342).

In one example use of the apparatus 100, the retail customer may need to make a color choice decision. For example, if the apparatus 100 is being used in conjunction with a hair color product recommendation system, and the customer's hair color analysis results in a bimodal distribution (i.e., primarily two colors are present), the apparatus 100 may ask the customer to choose one of the two colors as the preferred color. Accordingly, the apparatus 100 may display the two choices on an output device 114 (block 344) and receive a selection from the customer (block 346). For example, the apparatus 100 may display two polygon areas of color on a touch sensitive display 114 which may be touched to indicate a selection.

Regardless of whether a selection by the consumer is requested, the apparatus 100 may transfer data indicative of the measurement to a personal care product recommendation system (block 348). The personal care product recommendation system may be implemented in software and executed by the controller 102. When the personal care product recommendation system determines one or more recommend products and/or services, those products and/or service may be displayed to the retail customer via an output device 114 (block 350). For example, the apparatus may display a product name and/or a color.

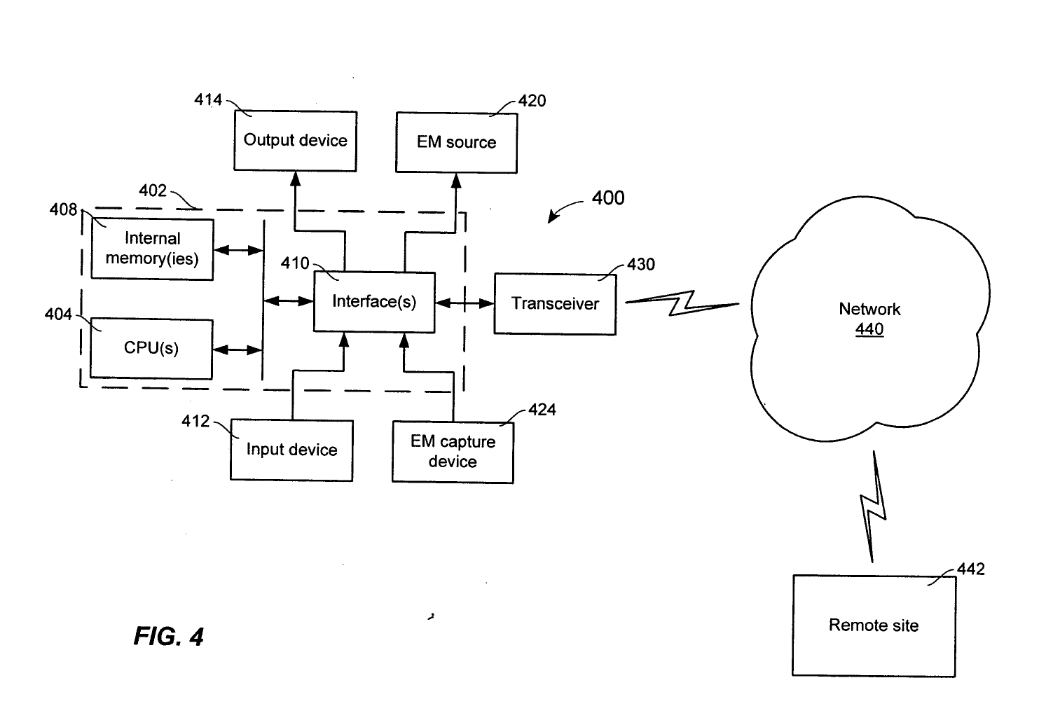

A block diagram of an alternative apparatus 400 structured to create and capture electromagnetic waves is illustrated in FIG. 4, which apparatus may be used in conjunction with a remote site for the generation of personal care product recommendations. The apparatus 400 includes a controller 402 which may include one or more processing units 404 operatively coupled to one or more memory devices 408 and one or more interface circuits 410. In turn, the one or more interface circuits 410 may be operatively coupled to one or more input devices 412, one or more output devices 414, an electromagnetic source 420 and an electromagnetic capture device 424.

As noted above, the one or more processing units 404 may be of a variety of types, for example including microprocessors, microcontrollers, etc. The memory device(s) 408 may include volatile memory and/or non-volatile memory. The memory device(s) 408 may store one or more programs that control the function of the apparatus. The memory device(s) 408 may also store data indicative of screen displays, bit maps, user instructions, personal identification information, demographic data, digitized images, color data, light intensity data, histogram data, and/or other data used by the apparatus 400 and/or collected by the apparatus 400. The interface circuit 410 may implement any of a variety of standards.

The one or more input devices 412 may be used to receive data, signals, identification information, commands, and/or other information from the user of the apparatus 400. For example, the one or more input device 412 may include one or more keys or buttons, and/or a touch screen. The one or more output devices 414 may be used to display or convey prompts, instructions, data, recommendations and/or other information to the user of the apparatus 400. For example, the one or more output devices 414 may include one or more displays, lights, and/or speakers. Where the apparatus is in the form of a user-operated mobile device or system, as described below, the output devices 414 may include a liquid crystal display (LCD) and a speaker.

The capture device 424 generates color data from a substrate of interest and one or more calibration standards, potentially in conjunction with the source 420. The capture devices 424 may include CCDs or CMOS devices, as was the case with the embodiment described above relative to FIG. 1. As also noted above, the substrate of interest may take any of a number of forms, including for example the skin, eyes or teeth of the user of the apparatus 400. The calibration standard(s) may be as described above relative to FIG. 2, and may include a sample with one or more regions whose light intensity characteristics are known to the system as described below.

It will also be recognized that the apparatus 400 may be used with a holder for the substrate and/or the standards, or the combination of filters and lens described above. For example, a strap holder may be used to position the standard against the user's skin, like a wrist-watch band or head band, while the lens and filters may be disposed in an adapter that may be fitted over the capture device 424. Only one of the holder(s) and/or filters/lens may be used, or the holders and filter/lens may be omitted altogether. Where the holders are omitted, the standards may be disposed adjacent to or overlying the substrate; for example, where the substrate is skin, the standard(s) may be placed up against the skin of interest and held there manually. In any event, where the standard is held against the skin, tooth, hair or other substrate, it may not be necessary to provide an attenuating filter because the substrate and the standard will be a substantially the same distance relative to the capture device 424.

According then to at least one embodiment of the alternative apparatus 400, the apparatus 400 may be a device or system all or a part of which is mobile, and which may be owned and operated by the user/customer, permitting the user of the apparatus 400 to send for and receive product recommendations at a wide variety of locations. To this end, the apparatus 400 may include a transceiver 430 that permits the apparatus 400 to communicate via a network 440 with a remote site 442 without the use of a wired connection between at least the apparatus 400 and the network 440. The transceiver 430 may be an infrared transceiver, for example. Alternatively, the transceiver may be a radio-frequency (RF) transceiver. Moreover, while the transceiver 430 is illustrated as a single element in FIG. 4, the transceiver 430 may be defined by a combined circuit that provides both transmission and reception, or may be defined by separate circuits for transmission and reception.

Thus, it will be recognized that the apparatus 400 may defined by a mobile unit, such as is commonly referred to as a cellular or mobile telephone, and in particular a cellular or mobile telephone incorporating an digital camera device. Such a device may be referred to herein as a unitary hand-held device. According to such an embodiment, the digital camera may be defined by, at least in part, a charge coupled device (CCD) or a complementary metal oxide semiconductor (CMOS) device, as is described above relative to the apparatus 100. The transceiver 430 may communicate with the network 440 using RF signals in accordance with any of a number of standards.

It will also be recognized that the apparatus 400 may be defined by a mobile system comprised of a combination of separate devices, each device defining a portion of the apparatus 400. For example, the apparatus 400 may include a hand-held device, such as a digital camera, which may include a controller 400, the electromagnetic source 420 and the electromagnetic capture device 424, and a computer, which may also include a controller 400, as well as the input and output devices 412, 414 and the transceiver 430. According to such an embodiment, the digital camera may communicate with the computer over a hard-wire connection (e.g., a cable or the like) or may be in communication with the computer using a wireless connection (e.g., infrared). For that matter, a memory device, such as a compact flash (CF) card or the like, may be removed from the camera and placed in a reader for such devices that is operatively coupled to the computer. For its part, the computer may be in communication with the network 440 much like the mobile device above, i.e., using an RF signal in accordance with any of a number of standards. Alternatively, the computer may be in communication with the network 400, for example, by coupling the computer to a router or hub via a wired or wireless (e.g., infrared) link, the router or hub then being in communication with the remainder of the network 440 (e.g., the Internet).

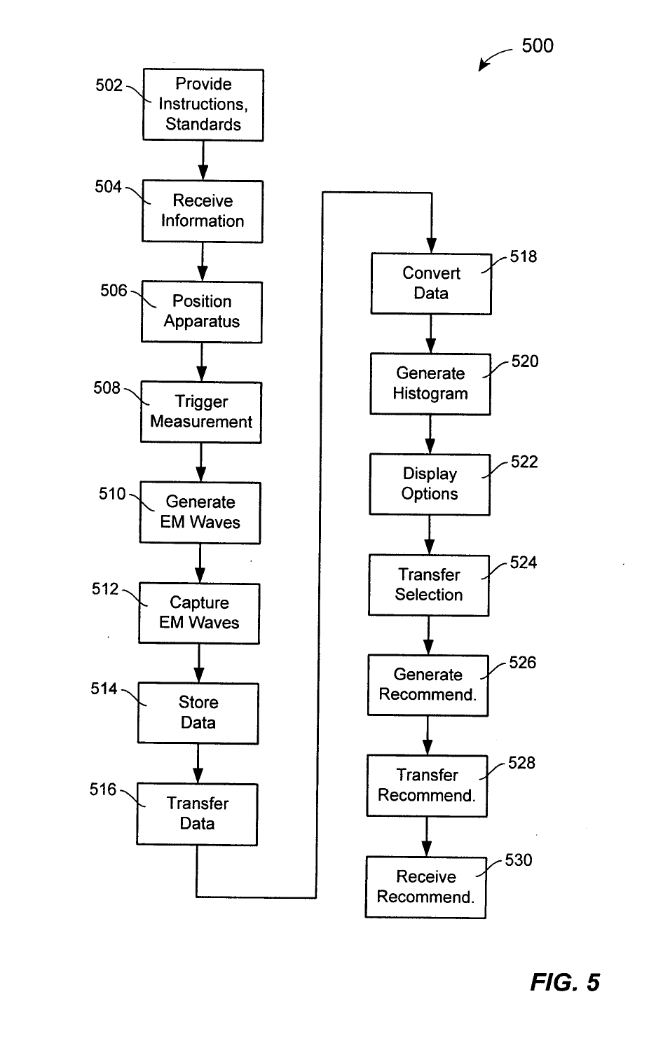

A flowchart of an embodiment of an alternative process 500 for receiving or providing product recommendations is illustrated in FIG. 5; that is, the process includes certain steps that may be performed by the user to request and receive the recommendation, while others may be conducted by a manufacturer, retailer, etc. to generate and provide the recommendation. Although the process 500 is described with reference to the flowchart illustrated in FIG. 5, it will be recognized that many other ways for carrying out the process 500 may exist. For example, the order of the steps may be varied, and certain steps may be treated as optional or omitted altogether. Also, at least part of the process 500 may be embodied in a software program which is stored in a controller memory 408 and executed by the processing unit 404 in a well known manner. However, certain of the steps of the process 500 may be performed other devices associated with the network 440, the remote site 442 for example.

Generally, the process 500 may begin at blocks 502, 504 depending on the implementation of the apparatus 400. The blocks 502, 504 include activities that provide the user with information and calibration standards, and request information from the user. For example, at the block 502, the user may be provided with the calibration standards and the instructions on the steps that must be carried out to receive the product recommendation, including instructions on how to position the apparatus 400 and the standards, how to trigger the apparatus 400 to obtain a digital representation of the substrate, how to input information on person preferences, and how to transmit the digital representation and the personal preference information over the network 440. Where the embodiment of the apparatus 400 includes a substrate alignment device, such as a pair of eye positioning frames, the instructions may describe their operation. At the block 504, the user may receive a series of prompts that request certain personal preference and/or personal identification information. In such an instance, the apparatus 400 may receive the personal preference and/or personal identification information via one or more input devices 412 and may store the personal preference and/or personal identification information in a memory 408.

The process 500 continues with the positioning of the electromagnetic source 420, the electromagnetic capture device 424, and standards at block 506. It will be recognized that the exact implementation of this step will vary in accordance with the nature of the embodiment of the apparatus 400. Where the apparatus 400 takes the form of a mobile cell phone with integral digital camera, the block 506 may include holding the cell phone so at to point the camera at the substrate of interest. Where the apparatus 400 takes the form of a camera used in combination with a portable computer, the camera may be directed at the substrate, while the location of the computer is not relevant to actions taken at this block. Further, where provided, an alignment device may be used with the substrate. Further, the positioning of the standard(s) may involving laying the standard(s) on the substrate or holding them in place; a holder may be provided to perform this action according to certain embodiments.

Once the user self-aligns the standards and the substrate, for example a portion of his/her body, with the apparatus 400 at block 506, the user triggers an electromagnetic measurement at block 508. In response, the apparatus 400 may generate electromagnetic waves and captures waves from the standard(s) and the substrate at blocks 510, 512.

Different waves captured by the electromagnetic capture device 424 at different X-Y coordinates of the electromagnetic capture device 424 may be stored separately in a two-dimensional data matrix at block 514. According to one embodiment of the present disclosure of the apparatus 40, the matrix may be in the form of a digital image, and the representation of the wave captured at a particular X-Y coordinate (pixel) may be a particular light intensity. This two-dimensional matrix may be stored in conjunction with the personal preference and/or the personal identification data associated with this retail customer.

At this point, the information gathered from the user of the apparatus 400 may be transferred from the mobile unit 400 to a remote site 442 via the network 440 at block 516. For example, the identification and personal preference information gathered from the user may be sent to the remote site 442, along with the two-dimensional matrix, via an electronic mail system, with the information either as attachments or embedded in the e-mail. For that matter, the information may be uploaded from the mobile unit/apparatus 400 to the remote site 442 over the network 440. The uploading may occur via the Internet, either via a secure or unsecured site, or may occur via a direct line connection.

The light intensity values of the matrix may be further processed prior to the generation of the product recommendation. While these steps may take place within or at the apparatus 400, it may be more convenient to perform these activities at the remote site 442 after the transfer step of block 516. For example, the light intensity values may be converted from one color space to another at block 518, and a histogram generated at block 520. For example, at block 518, the light intensity value may be converted from a RGB (red-green-blue) system to a LAB (light-yellow-red) and/or a LCH (light-chroma-hue) system. At the block 520, digital representations of the different waves, or converted versions thereof captured at the different X-Y coordinates of the electromagnetic capture device 424, may be combined in to a histogram by determining the light intensity values associated with each of the different X-Y coordinates and counting the number of occurrences of each light intensity value (or each of a range of light intensity values). It will be recognized may be converted from the original color space to any other color space at block 518 prior to or after creating a histogram at the block 520.

Based on the digital data, the customer is given certain choices and/or informed of certain personal care product recommendations. In one example of use of the apparatus 400, the retail customer may need to make a color choice decision. For example, if the apparatus 400 is being used in conjunction with a hair color product recommendation system, and the customer's hair color analysis results in a bimodal distribution (i.e., primarily two colors are present), the apparatus 400 may ask the customer to choose one of the two colors as the preferred color. Accordingly, the apparatus 400 may display the two choices on an output device 414 (block 522) and receive a selection from the customer (block 524). For example, the apparatus 400 may display two polygon areas of color on a touch sensitive display 414 which may be touched to indicate a selection.

Depending on the various inputs received from the apparatus 400 (personal preference, personal identification, light intensity matrix, option selection), the remote site 442 will generate one or more product and/or service recommendations at block 526. These recommendations are then transferred from the remote site 442 to the apparatus 400 at block 528. The recommended products and/or services may then be displayed to the retail customer via one of the output devices 414 at block 530. For example, the apparatus may display a product name and/or a color.

In summary, persons of ordinary skill in the art will readily appreciate that methods and apparatus for measuring an electromagnetic radiation response property associated with a substrate have been provided. The foregoing description has been presented for the purposes of illustration and description. It is not intended to be exhaustive or to limit the invention to the example embodiments disclosed. Many modifications and variations are possible in light of the above teachings. It is intended that the scope of the invention not be limited by this detailed description of example embodiments, but rather by the claims appended hereto.

All documents cited in the Detailed Description of the Invention are, in relevant part, incorporated herein by reference; the citation of any document is not to be construed as an admission that it is prior art with respect to the present invention.

While particular embodiments of the present invention have been illustrated and described, it would be obvious to those skilled in the art that various other changes and modifications can be made without departing from the spirit and scope of the invention. It is therefore intended to cover in the appended claims all such changes and modifications that are within the scope of this invention.

What is claimed is:

1. A method of receiving a personal care product recommendation, the method comprising:
aligning a hand-held device including an electromagnetic capture device with a target substrate and one or more calibration standards;
capturing a portion of the electromagnetic waves from the substrate and the one or more calibration standards using the electromagnetic capture device;
transferring to a remote site an electronic representation of the captured electromagnetic waves from the substrate and the one or more calibration standards in the form of a two-dimensional matrix; and
receiving from the remote site a recommendation of a personal care product according to the electronic representation.

2. A method as defined in claim 1, wherein the hand-held device is a unitary hand-held device.

3. A method as defined in claim 2, wherein the unitary hand-held device is a cellular phone with integral digital camera.

4. A method as defined in claim 1, further comprising generating electromagnetic waves.

5. A method as defined in claim 4, wherein generating electromagnetic waves comprises activating a flash.

6. A method as defined in claim 4, wherein generating electromagnetic waves comprises activating at least two flashes.

7. A method as defined in claim 1, wherein capturing a portion of the electromagnetic waves comprises receiving the portion of the electromagnetic waves via at least one of a charge coupled device and a CMOS device.

8. A method as defined in claim 1, wherein transmitting the electronic representation comprises transmitting data having a light component, a red component, and a yellow component.

9. A method as defined in claim 1, wherein transmitting the electronic representation comprises transferring data having a red component, a green component, and a blue component.

10. A method as defined in claim 1, further comprising storing a two-dimensional data matrix and personal preference information associated with the two-dimensional data matrix.

11. A method as defined in claim 1, wherein said method further comprises:
making a selection indicative of one of a first color and a second color; and
transferring the selection to the remote site,
wherein receiving the recommendation from the remote site of a personal care product comprises receiving from the remote site a recommendation of a personal care product according to the electronic representation and the selection.

12. A method of generating a personal care product recommendation, the method comprising:
providing one or more calibration standards to a user;
instructing a user to align a hand-held device including an electromagnetic capture device with a target substrate and the one or more calibration standards;
instructing the user to capture a portion of the electromagnetic waves from the substrate and the one or more calibration standards using an electromagnetic capture device;
receiving an electronic representation of the captured electromagnetic waves from the substrate and the one or more calibration standards in the form of a two-dimensional matrix to a remote site; and
generating a recommendation of a personal care product according to the electronic representation.

13. A method as defined in claim 12, wherein the hand-held device is a unitary hand-held device.

14. A method as defined in claim 14, wherein the unitary hand-held device is a cellular phone with integral digital camera.

15. A method as defined in claim 12, further comprising:
instructing the user to provide personal preference information; and
receiving the personal preference information,
generating a recommendation of a personal care product comprising generating a recommendation of a personal care product according to the electronic representation and the personal preference information.

16. A method as defined in claim 12, wherein receiving the electronic representation comprises transmitting data having a light component, a red component, and a yellow component.

17. A method as defined in claim 12, wherein receiving the electronic representation comprises transferring data having a red component, a green component, and a blue component.

18. A method as defined in claim 17, further comprising converting an RGB value to an LAB value.

19. A method as defined in claim 12, further comprising generating a histogram according to the electronic representation.

20. A method as defined in claim 12, wherein said method further comprises:
receiving a selection indicative of one of a first color and a second color from the user, wherein generating the recommendation of a personal care product comprises generating a recommendation of a personal care product according to the electronic representation and the selection.
